(19) United States
(12) Patent Application Publication
(10) Pub. No.: US 2005/0182930 A1
(43) Pub. Date: Aug. 18, 2005

(54) Method and a device for transforming an operating system to protect a computer program against attack

(75) Inventor: Didier Helou, Saint Cyr L'ecole (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/059,400

(22) Filed: Feb. 17, 2005

(30) Foreign Application Priority Data
Feb. 18, 2004 (FR) 04 50 299

(51) Int. Cl. G06F 9/45

(52) U.S. Cl. 713/164

(57) ABSTRACT

A device (D) is dedicated to transforming an operating system (OS), where applicable within an equipment (PC). The device (D) comprises processing means (MT) for scrambling one or more program support tool(s) (Fst, Fct) of the operating system (OS) by inserting one or more scrambling parameters into its definition.

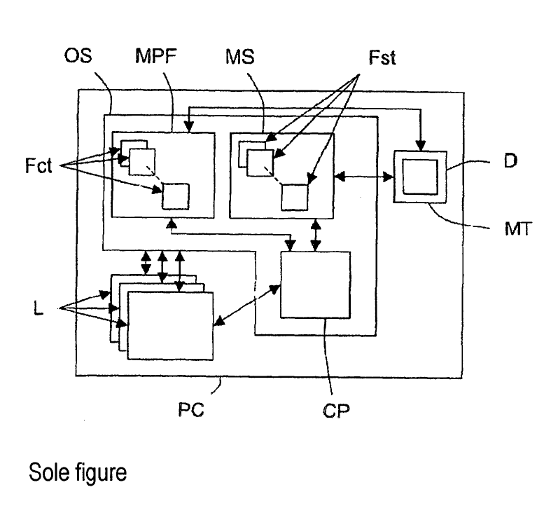

The field of the invention is that of equipment managed by an operating system and one or more computer programs compiled by that operating system.

In the present context, the term “equipment” refers to any type of hardware controlled by compiled programs, and in particular fixed or portable computers, workstations, network equipments such as servers or routers, and fixed or mobile communication terminals, including multimedia terminals, such as telephones and personal digital assistants (PDA), for example.

Almost all computer programs, and even software, compiled using an operating system (OS), regardless of which operating system, may be attacked by programs that are generally referred to as “binaries” because they consist of binary code.

These binaries are frequently classified into families such as worms, viruses, Trojan horses, spyware or data miners, according to how they work. They enable their designers to recover information stored or entered in an equipment in real time, control an equipment remotely, destroy data or parts of internal programs or software stored in an equipment (including those constituting the OS), or constrain internal programs or software stored in an equipment to execute unauthorized binary code, for example to effect demonstrations or to submit them to tests.

These binaries exploit the security weaknesses of the internal programs. It is possible to remedy these defects by means of corrective programs (known as “patches”), but the time needed to develop a corrective program dedicated to one binary and to execute tests known as regression tests is rarely less than one week, which allows the binary to continue to operate and may not prevent other binaries from operating freely. Moreover, adding a corrective program can sometimes interfere with or even prevent the operation of applications.

Moreover, certain internal programs or software may unintentionally create access ports (security holes) for external binaries or eliminate safety ports initially designed to block external binaries in internal programs or software with which they cooperate. This may make it impossible to restore certain installation files and consequently impose complete reinstallation of a data processing system.

Thus an object of the invention is to improve on this situation.

To this end it proposes a method of protecting an internal computer program against attack by one or more external computer programs. The internal computer program runs on an equipment having an operating system. The method is characterized in that it scrambles said operating system and then uses the scrambled operating system to compile said internal program.

To scramble it, the operating system is preferably transformed by scrambling one or more of its programming support tools by inserting into its definition one or more scrambling parameters.

It is preferable if all the program support tools are scrambled. Moreover, if each support tool is defined by a multiplet including parameters or variables (associated with a type) it is also preferable if a scrambling parameter is inserted before or after each parameter or variable of a multiplet.

Scrambling may equally consist in permutating two or more variables or parameters, and preferably all variables or parameters, of one or more of said multiplets, and preferably all of said multiplets, in addition to inserting scrambling parameters.

Scrambling may be effected as a function of a selected law, preferably a variable law, for example a pseudorandom law.

The programming support tool(s) are preferably selected from function prototypes and internal include files each defining a structure.

For example, each scrambled function prototype (Fct) may be defined by a multiplet taking the form “Fct(typei Pi, [type Dummyi,] typej Pj, [type Dummyj,] . . . typer Pr, [type Dummyr])”, where “typei” is the type i of the call parameter Pi of the function concerned and “Dummyi” represents one or more inserted scrambling parameters associated with the call parameter Pi. Similarly, each scrambled internal include file (Fst) may be defined by a multiplet taking the form “Fst{typei Di,[type Dummyi;] typej Dj, [type Dummyj,] . . . typer Dr, [type Dummyr]}, where “typei” is the type i of the variable Di of the structure concerned and “Dummyi” represents one or more inserted scrambling parameters associated with the variable Di.

The invention also proposes a data processing device dedicated to the protection of a computer program and comprising processing means for executing a method of the type defined hereinabove.

The invention is particularly well suited, although not exclusively so, to scrambling operating systems such as “LINUX”, “BSD”, “Solaris”, “Tru64” and “WINDOWS” (registered trade marks).

Other features and advantages of the invention will become apparent on reading the following detailed description and examining the appended drawing, which is a single figure showing one highly diagrammatic example of a computer equipped with a transformation device of the invention. The appended drawing constitutes part of the description of the invention as well as contributing to the definition of the invention, if necessary.

An object of the invention is to protect computer programs (or software) against attack by other computer programs, for example binaries.

The invention relates to any type of computer program that has to be compiled by a compiler forming part of an operating system (OS) in order to function within an equipment. The invention relates to any type of operating system, whether of the single-tasking or multitasking type, and in particular the following operating systems: “UNIX”, “LINUX”, “BSD”, “Solaris”, “Tru64”, “OS/2”, “BeOS”, “MS-DOS”, “WINDOWS” and “MacOS” (registered trade marks).

The following description relates to the LINUX operating system as installed in a fixed or portable computer. Of course, it could be installed, or be adapted to be installed, in any other type of equipment controlled at least in part by compiled computer programs, and in particular in a workstation or a network equipment, such as a server or a router, or in a fixed or mobile communication terminal, possibly a multimedia terminal, such as a telephone or a personal digital assistant (PDA).

As shown in the single figure, a personal computer PC usually comprises an operating system OS coupled to one or more computer programs or application software packages L dedicated, for example, to sending and receiving electronic mail, accessing a private or public network, such as the Internet, processing text or photographs, reading and/or writing digital data, games or digital simulation.

An operating system OS consists of software for controlling the operation of a personal computer PC, and in particular for managing the allocation and use of hardware resources such as memory, the central processor unit (CPU), hard disk and peripherals, for example. It also serves as a command interface with the personal computer PC and in particular with the application software L that it contains.

In very simple terms, an operating system OS includes a first module MPF comprising a first type of programming support tool Fct, a second module MS comprising a second type of programming support tool Fst, and a compiler CP for compiling internal programs or software L using the support tools of the first module MPF and the second module MS so that they can function within the personal computer PC.

In the present context the expression “first type of support tool” means what the person skilled in the art usually calls a function prototype Fct. A function prototype Fct constitutes a semantic description of a programming function and frequently defines an application programming interface (API). It is usually defined by a multiplet designated by a name and taking the form Fct(type1 P1, type2 P2, . . . , typen Pn), where “typei” is the type i (i=1 to n, where n varies according to the function) of a parameter Pi for calling the function concerned. There are generally eight different types: four scalar types (Boolean, integer, floating point number, character string), two composite types (array and object) and two special types (resource and Null). Mixed types may be provided for call parameters Pi that may have different types.

Examples that may be cited include the Kernel, Library, Driver and Application functions. There follows an illustrative example of the Kernel function:
struct file *file, /* The read file */
char *buf, /* The buffer to use */
size_t len, /* The length of the buffer */
off_t *offset) /* Offset in the file—ignore */

In the present context, the expression “second type of support tool” means what the person skilled in the art usually refers to as an internal include file Fst. An internal include file Fst constitutes a semantic description of a programming structure used in a program. It is usually defined by a multiplet designated by a name and taking the form Fst {type 1 D1; type 2 D2; . . . ; typem Dm}, where “typei” is the type i (i=1 to m, where m varies according to the structure) of a variable Di of the structure concerned. The types are generally the same as those used for the function prototypes Fct.

A function is generally called with an associated structure. There follows an illustrative example of a structure calling a plurality of variables Di: struct zatm_vcc{
int rx_chan; /* RX channel, 0 if none */
int pool; /* set of buffers */
int tx_chan; /* TX channel, 0 if none */
int shaper; /* profiler, <0 if none */
struct sk_buff_head tx_queue; /* list of buffers */
wait_queue_head_t tx_wait; /* to close */
u32 *ring; /* transmission ring */
int ring_curr; /* current writing position */
int txing; /* number of transmissions */
struct sk_buff_head backlog; /* list of buffers */};

To protect the computer programs (or software) against attack by other computer programs, such as binaries, for example, the invention proposes to compile them with a conventional compiler CP after the operating system OS has been scrambled.

A method in accordance with the invention of scrambling the operating system OS (for example the LINUX operating system (registered trade mark)) inserts one or more dummy scrambling parameters into the definition of one or more of its programming support tools of the first type Fct and the second type Fst.

The purpose of this is to offset the order of the parameters in the stack in which they are stored. Thus an external binary that has not been compiled with the same operating system OS as the internal software that it is attacking will receive error codes in response to its requests or very quickly become unusable, causing the application to crash.

The protection conferred by scrambling on software (or a program) compiled by the scrambled operating system increases in proportion to the number of scrambled support tools. In other words, it is preferable to scramble all the support tools of the first and second types, i.e. all the function prototypes Fct and all the internal include files Fst.

Scrambling may entail inserting one or more scrambling parameters Dummyi before or after one or more of the call parameters Pi or one or more of the variables Di. A scrambling parameter Dummyi may be selected as a function of a law, which may vary from one operating system to another, and possibly from a support tool Fct of the first type to a support tool Fst of the second type. The law preferably varies in a pseudorandom manner.

Moreover, a scrambling parameter Dummyi may be of variable type. For example, it may consist of one or more bytes or even a string of bytes.

Protection is even more effective if a scrambling parameter is inserted before or after each parameter Pi or variable Di of a multiplet defining a function or a structure. This kind of scrambling leads to the following scrambled definitions for each function prototype Fct and each internal include file Fst when it is applied after the call parameters Pi or the variables Di:
Fct(type1 P1, [type Dummy1,] type2 P2,[type Dummy2,] . . . , typen Pn, [type Dummyn])
Fst {type1 D1; [type Dummy1;] type2 D2; [type Dummy2;] . . . , typem Dm; [type Dummyn])

Alternatively, the following scrambled definitions are obtained if scrambling is applied before the call parameters Pi or the variables Di:
Fct ([type Dummy1,] type1 P1, [type Dummy2,] type2 P2, . . . , [type Dummyn] typen Pn)
Fst([type Dummy1;] type1 D1, [type Dummy2;] type2 D2; . . . ; [type Dummym;] typem Dm}

In this example of scrambling, the scrambling parameters Dummyi may be selected as a function of a law, which may vary from one operating system to another and possibly from a support tool Fct of the first type to a support tool Fst of the second type. The law preferably varies in a pseudorandom manner.

Protection may be even more effective if scrambling not only inserts one or more scrambling parameters but also permutates two or more call parameters Pi, Pj or variables Di, Dj within one or more definition multiplets, preferably in each definition multiplet.

Protection of optimum effectiveness is obtained if all the call parameters Pi and all the variables Di are permutated within each function and structure definition multiplet. This kind of scrambling leads to the following scrambled definitions for each for each function prototype Fct and each internal include file Fst when it is applied after the call parameters Pi or the variables Di:
Fct(typei Pi, [type Dummyi,] typej Pj,[type Dummyj,] . . . , typer Pr, [type Dummyr])
Fst {typej Dj, [type Dummyj,] typer Dr,[type Dummyr,]; . . .; typei Di, [type Dummyi]}

Alternatively, if scrambling is applied before the call parameters Pi or the variables Di, the following scrambled definitions are obtained:
Fct ([type Dummyi,] typei Pi, [type Dummyj,] typej Pj, . . . , [type Dummyr,] typer Pr)
Fst {[type Dummyj;] typej Dj; [type Dummyr;] typer Dr; . . . ; [type Dummyi;] typei Di}

In this example of scrambling, the permutations, and where applicable the scrambling parameters Dummyi, may be selected as a function of a law, which may vary from one operating system to another and possibly from a support tool Fct of the first type to a support tool Fst of the second type. The law preferably varies in a pseudorandom manner.

Once an operating system OS has been scrambled in accordance with the invention, it can be used to protect a computer program against attack. To this end, it suffices to use the compiler CP of the scrambled operating system OS to compile the computer program, as the compiler CP will use its scrambled support tools.

As indicated above, an external binary that has not been compiled using the same operating system OS as the software that it is attacking will receive error codes in response to its requests or will become unusable very quickly. A binary that did not call APIs of the scrambled operating system could of course attack a program protected in accordance with the invention, but its actions would then be very limited; in particular, retrieving data via the Internet would be very difficult because the standard TCP/IP functions would be unusable.

The scrambling may be effected using a protection device D of the invention. A device D of this kind requires only a processing module MT for scrambling one or more support tools by inserting scrambling parameter(s) and where applicable by permutating call parameters or variables. To this end, the processing module MT must have access to a stack of scrambling parameters stored in a dedicated memory (in the form of a table or file(s), for example) and possibly access to a law, as described above, depending on its configuration.

The processing device D, and in particular its processing module MT, may be implemented in the form of electronic circuits, software (or data processing) modules, or a combination of circuits and software.

A device D of the above kind may be integrated into an equipment, as shown in the single figure, take the form of an external peripheral that is connected to an equipment, or take the form of transformation software stored on a memory medium such as a CD-ROM, for example, a magneto-optical disc, or any other type of removable storage. However, it may equally be installed in an accessory dedicated to transforming operating systems by scrambling them and independent of the equipments to be equipped with said scrambled operating systems. This kind of accessory may equally be adapted to compile software (or programs) intended to function with an operating system that it has scrambled beforehand.

Thanks to the invention, software compiled with a scrambled operating system is protected against attack based on calls to the APIs of the operating system.

Moreover, only internal software that has been compiled by a scrambled operating system can afterwards use other internal software compiled by the same scrambled operating system.

Furthermore, the invention dispenses with corrective programs (patches) and associated regression tests. This reduces development and installation costs, dispenses with indispensable adaptations in the event of modifying software, and does not leave software prey to attack during the phases of developing and testing corrective programs.

Moreover, the invention protects software having inherent security defects against attack.

The invention is not limited to the embodiments of the processing device, transformation method and protection method described above by way of example only, but encompasses all variants thereof that the person skilled in the art might envisage that fall within the scope of the following claims.

1. A method of protecting an internal computer program (L) running on an equipment having an operating system (OS) against attack by an external computer program, which method is characterized in that it scrambles said operating system (OS) and then uses the scrambled operating system (OS) to compile said internal program (L).

2. A protection method according to claim 1, wherein said computer operating system (OS) comprises programming support tool(s) (Fst, Fct) each provided with a definition and is scrambled by scrambling one or more of said programming support tool(s) of said operating system by inserting one or more scrambling parameters into its definition.

3. A method according to claim 2, characterized in that each support tool (Fst, Fct) is defined by a multiplet including parameters or variables and a scrambling parameter is inserted after each parameter or variable of a multiplet.

4. A method according to claim 2, characterized in that each support tool (Fst, Fct) is defined by a multiplet including parameters or variables and a scrambling parameter is inserted before each parameter or variable of a multiplet.

5. A method according to claim 2, characterized in that each support tool (Fst, Fct) is defined by a multiplet comprising parameters or variables and said scrambling is completed by permutating two or more parameters or variables of one or more of said multiplets.

6. A method according to claim 5 characterized in that all said parameters or all said variables of one or more of said multiplet are permutated.

7. A method according to claim 1, characterized in that scrambling is carried out as a function of a selected law.

8. A method according to claim 7, characterized in that said law is a variable law.

9. A method according to claim 7, characterized in that said law is a pseudorandom law.

10. A method according to claim 2, characterized in that all said support tool(s) (Fst, Fct) are scrambled.

11. A method according to claim 2, characterized in that said support tool(s) (Fst, Fct) are selected from function prototypes (Fct) and internal include files (Fst) defining structures.

12. A method according to claim 2, characterized in that said support tool(s) (Fst, Fct) are selected from function prototypes (Fct) and internal include files (Fst) defining structures, and further characterized in that each scrambled function prototype (Fct) is defined by a multiplet taking the form “Fct(typei Pi, [type Dummyi,] typej Pj, [type Dummyj,] . . . typer Pr, [type Dummyr])”, where “typei” is the type i of the call parameter Pi of the function concerned and “Dummyi” represents one or more inserted scrambling parameters associated with the call parameter Pi.

13. A method according to claim 2, characterized in that said support tool(s) (Fst, Fct) are selected from function prototypes (Fct) and internal include files (Fst) defining structures, and further characterized in that each scrambled internal include file (Fst) is defined by a multiplet taking the form “Fst {typei Di; [type Dummyi;] typej Dj; [type Dummyj;] . . . typer Dr; [type Dummyr]}, where “typei” is the type i of the variable Di of the structure concerned and “Dummyi” represents one or more inserted scrambling parameters associated with the variable Di.

14. A computer device (D), characterized in that it comprises processing means (MT) adapted to execute a method according to claim 1 of protecting internal computer programs (L).
